(19) United States
(12) Patent Application Publication
(10) Pub. No.: US 2010/0001996 A1
(43) Pub. Date: Jan. 7, 2010

(54) APPARATUS FOR GUIDING TOWARDS TARGETS DURING MOTION USING GPU PROCESSING

(75) Inventors: FEIMO SHEN, GRASS VALLEY, CA (US); RAMKRISHNAN NARAYANAN, NEVADA CITY, CA (US); JASJIT S. SURI, ROSEVILLE, CA (US)

Correspondence Address: MARSH, FISCHMANN & BREYFOGLE LLP, 8055 East Tufts Avenue, Suite 450, Denver, CO, 80237, US

(73) Assignee: EIGEN, LLC, GRASS VALLEY, CA (US)

(21) Appl. No.: 12/380,894

(22) Filed: Feb. 25, 2009

Related U.S. Application Data
(63) Continuation-in-part of application No. 12/359,029, filed on Jan. 23, 2009.
(60) Provisional application No. 61/032,373, filed on Feb. 28, 2008.

(51) Int. Cl. G06T 15/00

(52) U.S. Cl. 345/419

(57) ABSTRACT

A method and apparatus using a graphics processing unit (GPU) are disclosed for three-dimensional (3D) imaging and continuously updating organ shape and internal points for guiding targets during motion. It is suitable for image-guided surgery or operations because the speed of guidance is achieved close to video rate. The system incorporates different methods of rigid and non-rigid registration using the parallelism of GPU processing that allows continuous updates in substantially real-time.

### CROSS-REFERENCE TO RELATED APPLICATIONS

This application claims the benefit of U.S. Provisional Application No. 61/032,373 having a filing date of Feb. 28, 2008, the entire contents of which are incorporated by reference herein. This application is also a continuation-in-part of U.S. patent application Ser. No. 12/359,029 having a filing date of Jan. 23, 2009, the entire contents of which are incorporated herein by reference.

### BACKGROUND OF THE INVENTION

The present invention relates to medical imaging arts, in particular to 3D image guided surgery. It relates to an object undergoing rigid or non-rigid motion and analysis on it for tracking intra-operation translocations.

Image guided surgery is prevalent in modern operating rooms. The precision and accuracy of a surgical procedure for operating on specific targets located inside an organ or body depend on the knowledge of the exact locations of the targets. During a surgical procedure, the organ subject tends to move due to external physical disturbances, discomfort introduced by the procedure, or intrinsic peristalsis. Therefore, there is a need to trace the movement of the organ during such surgical procedures.

The first step to analyze is rigid motion of the images of objects, during which the surface shapes of the objects are kept constant. This situation usually rises when the tissue such as human or animal organs being examined, imaged, or manipulated in vivo is small and rigid. The second step is to analyze non-rigid motion by methods of warping following the first step. During a clinical or surgical operation, and the nature of the operation requires the image and guidance feedback to be in real-time.

Presently, many imaging modalities exist for in vivo imaging, for example, magnetic resonance imaging (MRI), X-ray computed tomography (CT), positron emission tomography (PET), and ultrasound. A prevalent imaging modality for real-time operation is ultrasound due to its low-cost of purchase, maintenance, and vast availability. It is an image modality of renewed interest because of the inexpensive and readily adaptable additions to current systems that are widely available in hospitals and clinics. However, ultrasound images have intrinsic speckles and shadows that make recognition difficult. Therefore, the problem of tracking with this modality is especially challenging due to the low signal-to-noise ratio (SNR) caused by speckle noise. Countering this problem, in this invention, we aim to use the ultrasound modality and the same computer algorithm but using the GPU to rapidly segment, reconstruct, and track the motion of an organ for keeping track of the targets during surgical procedures.

### SUMMARY OF THE INVENTION

A problem in this field is the speed of updating the translocation of the targeted areas caused by movement of the organ. The targets must be refreshed based on the newly acquired current state of volume position (see for example FIG. 1) at fast enough rate so that the doctor has updated information when operating. As illustrated, FIG. 1 shows a schematic diagram of a target translocated due to non-rigid motion of the organ (prostate) and the goal of updating the target aim (cross). The left diagram shows a pre-operative prostate boundary and the planned target at t₀. The middle diagram shows the boundary shape change due to a forceful push by the probe at t₁. The location of the shifted target is shown as a dotted circle. The needle biopsy, displayed as a dotted shadow, samples the originally planned position and misses the actual target region. The right diagram shows the updated boundary and target; the needle samples the corrected new target region It is therefore an objective of the current invention to trace the shifts of the targets based on the imaged current position to renew target coordinates at close to video rate.

One objective of this invention is to introduce a method and an apparatus system that finds and renews the position and shape change of the volume of interest and targets within it, and display a refreshed model on screen with guidance (an animation) for the entire duration of the procedure in real-time.

Another objective is to incorporate different methods of rigid and non-rigid registration using the parallelism of GPU to accomplish the goal of fast updates.

Using a means of imaging a 3D volume, the grayscale value of the voxels of a 3D image is obtained. The entire volume information is stored in computer memory. Using a means of finding location of an event or state of interest, targets will be spatially assigned within a control volume at t₀ (V₀). The surface of V₀ will be obtained via 3D image segmentation from the raw 2D sections. The surface of the volume is rendered in silico.

Following this, the targets of interest are assigned and planned within V₀. During the target intersecting procedure following the planning, the same imaging transducer probe, which has the target intersecting instrument attached, is used to image V₀ while the intersecting agent aims for the given targets. During this stage, the probe or other agents may cause the control volume to shift or change shape so that the current volume (Vₙ) differs from V₀. This invention finds this difference by using a single 2D scan with a known position.

As the imaging operator uses the probe, a 2D plane, which is a slice of the volume at current time (Aₙ), is obtained in real-time. Also in real-time, the system records the probe position via the sensor attachment. From the model, the software then uses the x, y, z spatial coordinate of the current live frame and the original surface boundary V₀ to search for the corresponding plane that has similar image content. The search criterion can be one of many parameters that represent a comparison between the live (floating) image and the target (search) image by grayscale values of the pixels. Each pixel operation is independent therefore eligible for parallel processing by the GPU. Once this plane (Bₘ) is found, a transform (T) is calculated to change the position of Bₙ to the position of Bₘ. The software then applies T to the V₀ to compute the new, updated volume location Vₙ. This way, the old volume model is rotated and translated so that it matches the current position existing in space, i.e., correct intersecting of the target can be achieved.

A further objective is to find the shape change of the current 2D plane that contains the target to be intersected. After the current volume position is renewed, the operator maneuvers the probe-intersecting device toward the target. The real-time imaged plane is again automatically segmented to produce B_{c}. The system then uses GPU to parallelize the steps needed to find non-rigid warping that matches the 2D shapes. With interpolation, the targets are relocated to the current boundary shape. The target intersecting device is guided toward the new target location. The details of this series of operations will be disclosed in the following sections.

### DESCRIPTION OF FIGURES

FIG. 1 shows a schematic diagram of a target translocated due to non-rigid motion of the organ (prostate) and the goal of updating the target aim (cross). The left diagram shows a pre-operative prostate boundary and the planned target at t₀. The middle diagram shows the boundary shape change due to a forceful push by the probe at t₁. The location of the shifted target is shown as a dotted circle. The needle biopsy, displayed as a dotted shadow, samples the originally planned position and misses the actual target region. The right diagram shows the updated boundary and target; the needle samples the corrected new target region.

FIG. 2 shows a schematic diagram of capturing a 2D scan and segmenting it in real-time via GPU processing while the doctor maneuvers the probe-needle device. The segmented boundary at time n is called Bₙ. The image is then cropped to a region of interest (ROI) that contains the organ or body part and are stored in GPU memory.

FIG. 3 shows a schematic diagram of re-sampling the constructed 3D model according to the position and orientation of the current 2D frame acquired in FIG. 2 and the optimization algorithm. The 2D boundaries are obtained by slicing the 3D surface model reconstructed pre-operatively. Note that the three slices are not parallel. The entire process is performed in GPU paralleling for each image samples.

FIG. 4 shows the output from the 2D image search (found in FIG. 3). The vector a represents the parameters of the transformation from Bₙ to Bₘ. The search result leads to an updated prostate position by the found rotation and/or translation between the model prostate and the current prostate. The dotted and dashed lines represent current scanned plane. The solid lines represent found plane from the search.

FIG. 5 shows the 2D warping of the model section containing the target of focus to the current section imaged by the probe-needle assembly. The model section is sampled from the known updated 3D model obtained by using the rotation and translation found in FIG. 4. The current section is scanned by using the same rotation and translation so that it and the model section match.

FIG. 6 shows a schematic of the passing of data between CPU and GPU and their memories. The number of processors in the GPU is much more than the CPU, thus making parallel processing of pixel or voxel data very efficient in GPU.

FIG. 7 shows a schematic of the GPU tread batch processing. Each thread in the blocks in the GPU can carry out independent instructions from other threads. For image comparisons, it can be calculations for each pixel of the image.

FIG. 8 shows operation processing diagram of the overall process of motion analysis using GPU parallel processing. The 3D image acquisition processes is done before start of motion tracking. The 2D image acquisition and finding the result of 3D transformation are real-time processes.

FIG. 9 shows operation processing diagram of the detail processes of “Registration via optimization” in FIG. 8. The memory of 3D volume of organ in CPU is first uploaded to GPU device memory. The floating image in CPU, which are constantly updating at video rate, are uploaded to GPU memory on the fly, resulting the 3D transformation result being output in real-time.

FIG. 10 shows the job division architecture using GPU. Each pixel process can be carried out in one thread. At the end, the results of the thread outputs are collected to compute the cost function of the optimization calculation. Normalized cross-correlation (NCC) is used here as an example to measure cost.

FIG. 11 shows a flow diagram of the optimization. This diagram involves an iteration loop that tells when convergence is achieved when the cost or the error between the floating image and the target image have reached a small, pre-defined value. The end result is what is described in FIGS. 8 and 9 as the final output.

FIG. 12 shows an object process diagram of the acquisition of target image. This acquisition is described in FIG. 8. This diagram describes the processes involved for each pixel for target image acquisition. On the GPU, all pixels undergo the same processes in parallel.

FIG. 13 shows the parallel reduction summation after all pixels are completed in FIG. 12. After all pixel grayscale values are obtained such as the output of the OPD in FIG. 12, the sums of the pixel grayscale values or other processes required by the cost definition are carried out in parallel in the GPU.

FIG. 14 shows the non-rigid registration processes after rigid transformation is completed in FIGS. 11-13. An example of non-rigid registration is using radial basis functions to model the actual deformation.

### DETAILED DESCRIPTION OF EXAMPLE EMBODIMENTS

The image processing for finding the extent of motion is essentially a 3D registration task. An example of embodiment is an intensity-based method to use original grayscale values of the pixels of transrectal ultrasound (TRUS) images for registration. It is difficult to achieve real-time by processing data on the CPU, even in dual or quad cores. There are tens to hundreds of thousand of pixels needed to be processed for each comparison between the floating and target images. Each of these pixels can be transformed to new coordinates and interpolated independently of each other. CPU's have sequential processing power and multi-core CPU's can only allow limited multi-processing as it is only possible to run a few threads simultaneously.

It is very important to minimize the computation time as the patient will inevitably move during the procedure, especially in the case of biopsies, where patient is conscious during the procedure. For prostate biopsies, the 2D TRUS images are first acquired and reconstructed to 3D. This part has a constant operating time. The next part is shooting biopsy core needles into the prostate after targets have been planned. This part requires motion of the patient and the organ of biopsy to be tracked. It is important to have a real-time or near video rate speed of updating the position of the organ throughout the duration of this second part. Graphics processing units (GPU) have evolved into a computing powerhouse for general-purpose computation. The numerous multiprocessors, and fast parallel data cache dedicated to each multiprocessor may be exploited to run large data parallel tasks. The availability of general purpose GPU language will allow high intensity arithmetic calculations to be accomplished by the creation of several hundreds or thousands of data parallel threads. The implementation of the 2D to 3D or 3D to 3D registration on the GPU is a solution to the problem of speed in motion updates and target re-focusing.

Firstly, an embodiment of the invention will be described. It serves to provide significant clinical improvement for biopsy using TRUS guidance. By this imaging technique and the GPU processing power on the same computing unit as the acquisition unit, the prostate capsule is tracked and the internal area of any slices of it is interpolated via an elastic model so that the locations of the targets and of the control volume that encapsulates it are updated in real-time. Although the invention described herein with respect to a ultrasound imaging embodiment, this invention is applicable to a broad range of three-dimensional modalities and techniques, including MRI, CT, and PET, which are applicable to organs and body parts of humans and animals.

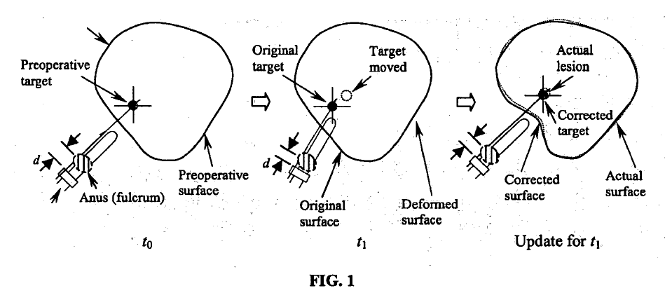

An overview of the operation with a TRUS probe is shown in FIG. 1. Via the schematic diagram, it demonstrates the problem and its solution according to the invention. This process progresses from left to right. The left-hand-side of the diagram shows a drawing of a 3D prostate surface with a 2D side view, a lesion within it (a gray dot), and a target location on top of it (a crosshair aim) calculated for sampling this lesion. The TRUS probe is shown on the lower-left corner of the prostate boundary with a mounted needle aimed and to be fired at it. The dotted shape of the needle indicates the furthest position of the needle when it is fired from the needle gun. This scheme shows a perfect situation in which the prostate or patient does not move at all between the planning and biopsy needle firing. The targeted region inside the boundary is successfully sampled. Because planning of the target takes place first, before any biopsy sampling is done, we label this situation as t₀.

However, usually due to patient movement (voluntary or involuntary) and doctor's handling of the TRUS probe inside the rectum, the prostate position is different from what was scanned at the planning stage of the biopsy test. Further due to the viscoelastic nature of prostate tissue, its shape usually deforms as well. FIG. 1 middle diagram shows such an example. The solid curve is the same shape as the prostate surface at t₀. The dotted curve shows the new surface when the probe forcefully pushes toward the prostate from the lower-left side at t₁. Note that the distance d between the needle channel mount and the anus is shortened from t₀ to t₁. Also note that the new shape at t₁ is not merely a Euclidean transform—the shape is deformed. Due to the elasticity of the organ, its internal matter elastically deforms as well. Therefore, the region of interest that contains the lesion is shifted from its original position. This new region is marked by a dotted circle inside the new surface. Presently, if the needle is still guided to shoot through the original target (crosshair over gray dot), then it will not sample the correct tissue region as shown in the diagram, i.e., the needle tip does not penetrate the dotted circle. There is a problem of locating the targets as the patient may continuously move and the targets cannot be tracked as the movement takes place. The current invention solves this problem by using GPU parallel processing to rapidly find the new position of the prostate boundary and re-focus the needle onto the updated target positions.

In FIG. 1, the right-hand-side diagram shows the result of an updated prostate boundary found by rescanning the prostate at t₁. The rescanned and reconstructed new surface is very close to the actual surface at t₁, which is represented by a dotted curve. Within it, the dotted circle representing the shifted new lesion region is now very close to the corrected target, which has a crosshair on top representing renewed target coordinates. The needle is then guided to fire toward this target and correctly samples a piece of tissue within the region containing the lesion. This strategy describe above will repeatedly scan the prostate to check for movement and update the corrected target positions accordingly in real-time. This will ensure correct sampling of all lesion regions. The details on carrying out the renewed focus of the needle are disclosed below.

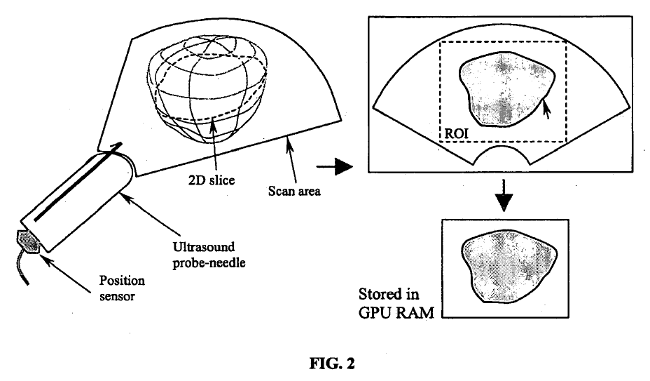

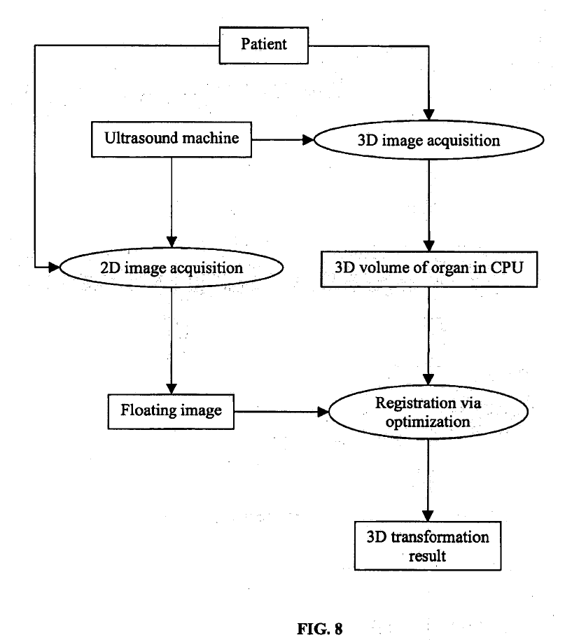

The information of the object of biopsy is obtained by scanning it using TRUS. The 3D spatial information is represented by the grayscale voxels of the structure. 2D TRUS images are scanned via a probe that has a position sensor attached to it (FIG. 2 left). A 3D image is constructed from the 2D images with known locations. The number of 2D images at different locations ensures high enough resolution for the final 3D image. The 3D image information is sent and uploaded to GPU memory in the form an array as soon as the acquisition is complete. This part is also represented in the object process diagrams in FIG. 8. The next part is acquisition of the floating image. FIG. 2 shows a schematic diagram capturing the floating image as a 2D scan. The segmentation of the boundary from the background of the image takes place in real-time while the doctor maneuvers the probe-needle device via GPU processing. The segmented boundary at time n is called Bₙ. The image is then cropped to a region of interest (ROI) that contains the organ or body part and is stored in GPU device memory.

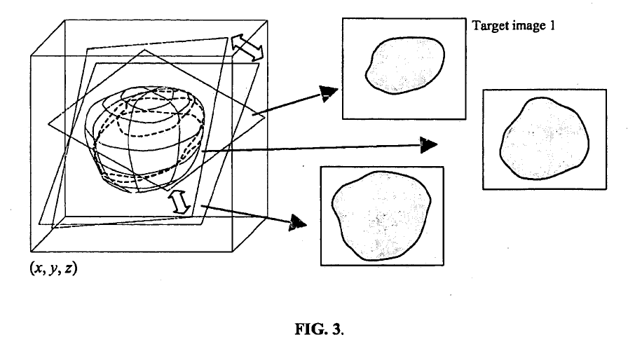

The position of the acquired 2D image during the maneuver is known via the position sensor attached to the probe. The algorithm then searches for a plane in the previously constructed model that contains the similar information as this 2D image. The found plane will tell the rotation and/or shift between the old model and the current prostate position. FIG. 3 shows the process of obtaining a search volume from the old model. The process flows according to the black arrow in the figure. In the left-hand-side diagram, the three slices cutting through the 3D model produces three different sampling of the search volume. Three non-parallel slices are obtained in this volume and are represented by grayscale images of the same size but of different content, as shown in the right-hand-side of the figure with their boundaries delineated. This process is computationally intensive, as it requires interpolation of the interior of the model store in GPU memory.

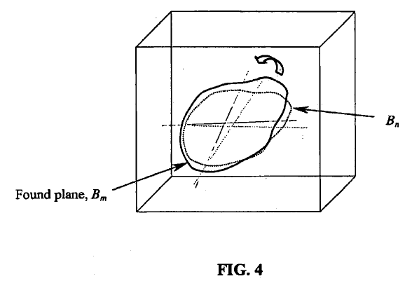

FIG. 4 shows the output from the 2D image search (found in FIG. 3). The search result leads to an updated prostate position by the found rotation and/or translation between the model prostate and the current prostate. The dotted/dashed lines represent current scanned plane. The solid lines represent found plane from the search. The search involves control points on Bₙ and uses a linear least-squares method to solve an optimization problem. The box shows a 3D representation of the current image or needle plane that contains Bₙ (dotted curve) and the found plane that contains same boundary Bₘ (solid curve). The rotational angle and translational shift, which are collectively called the notation α, shows the parameters of the transformation from Bₙ to Bₘ.

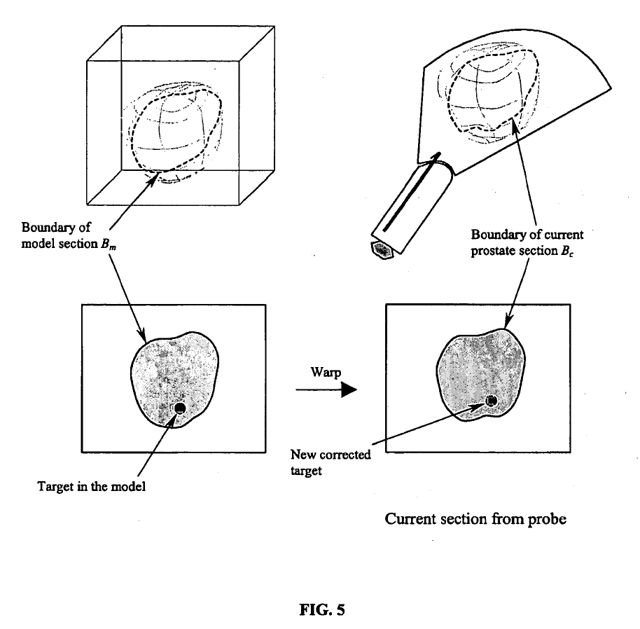

As a result of the transform, the algorithm then uses α to direct the positioning of the probe-needle device toward the updated plane that contains the current target. The doctor updates the position of the probe-needle device; at this moment, a new 2D scan that contains the target of interest becomes current. A rapid 2D segmentation is carried out again to delineate the boundary in this plane. Even though this plane should be the closest match to the updated model 2D section, to further increase biopsy accuracy, we apply a 2D warping to account for any planar deformation. The algorithm uses the two boundaries to warp the model section boundary Bₘ to fit the current section boundary B_{c}. An elastic deformation technique is used to interpolate the shift of the target based on the deformation of the 2D boundaries. FIG. 5 illustrates this process with an example.

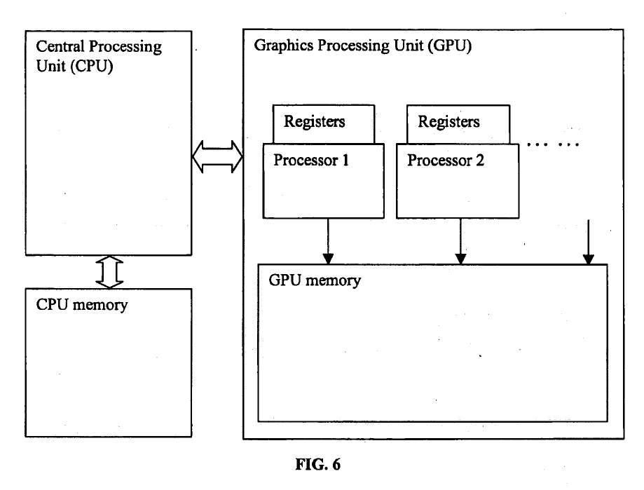

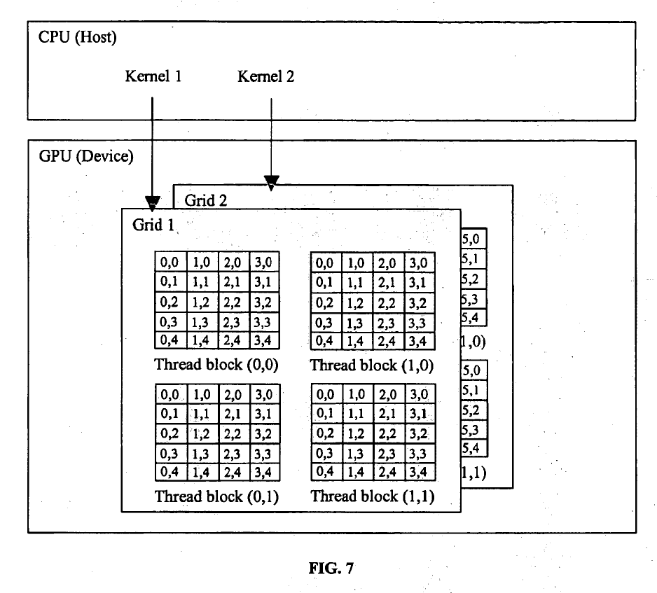

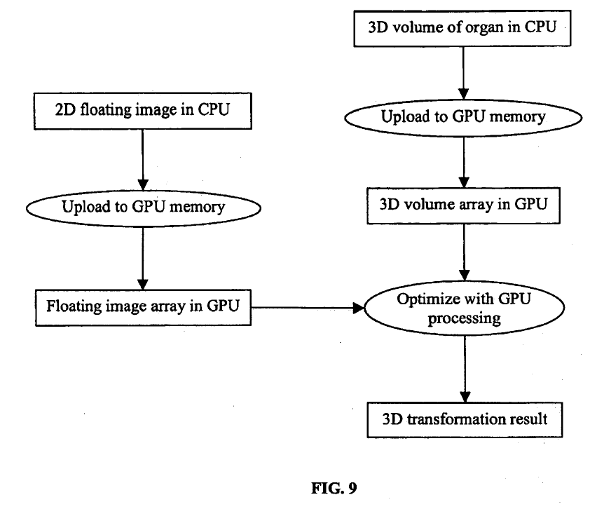

Secondly, a set of flow diagrams including object process diagrams (OPD) that summarizes the objects and process flow of this invention embodiment is presented. FIG. 6 and FIG. 7 describe the inner links between CPU and GPU. FIG. 8 describes the operation processing of the overall process of motion analysis using GPU parallel processing. FIGS. 9-13 show the detailed GPU threading operations for the registration problem using an optimization algorithm.

FIG. 6 shows a schematic of the passing of data between CPU and GPU and their memories. The number of processors in the GPU is much more than the CPU, thus making parallel processing of pixel or voxel data very efficient in GPU. However, data have to be passed from CPU memory to GPU memory. Data sizes are taken into consideration as limits of the register usage and device memory are observed. The schematic of the GPU tread batch processing is shown in FIG. 7. Each thread in the blocks in the GPU can carry out independent instructions from other threads. For image comparisons in this invention, it is calculations for each pixel of the image.

FIG. 8 shows operation processing diagram of the overall process of motion analysis using GPU parallel processing. Patient is scanned by the urologist via the ultrasound machine to obtain the information about the prostate in the form of grayscale image data. The reconstructed 3D image from a series of 2D images is stored and uploaded to GPU memory as described in FIG. 2.

FIG. 9 shows operation processing diagram of the detail processes of “Registration via optimization” in FIG. 8. The memory of 3D volume of organ in CPU is first uploaded to GPU device memory. This is the right column of the diagram, and is performed before the motion search is started. The left column of the diagram represents the real-time uploading of the floating image. The floating image in CPU, which are constantly updating at video rate, are uploaded to GPU memory on the fly, resulting the 3D transformation result being output in real-time. The middle operation “Optimize with GPU processing” is described in detail in the following figures.

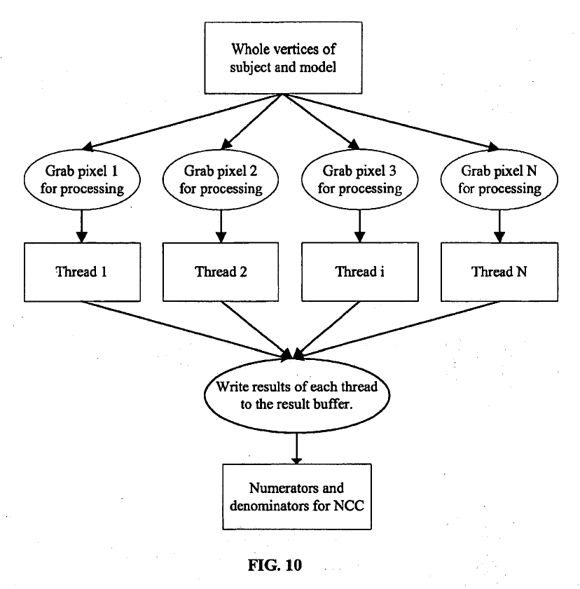

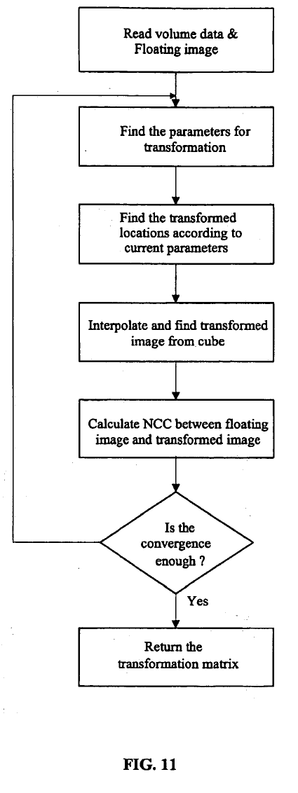

FIG. 10 shows the job division architecture using GPU. Each pixel process can be carried out in one thread. The threads are controlled by the GPU software kernel and synchronized for completion. At the end, the completed results of the thread outputs are collected to compute the cost function of the optimization calculation. Normalized cross-correlation (NCC) is used here as an example to measure cost. The optimization computation is described in FIG. 11 as a flow diagram. This diagram involves an iteration loop that tells when convergence is achieved when the cost or the error between the floating image and the target image have reached a small, pre-defined value. This part of the computation is carried out in CPU as the parallelism is non-existent.

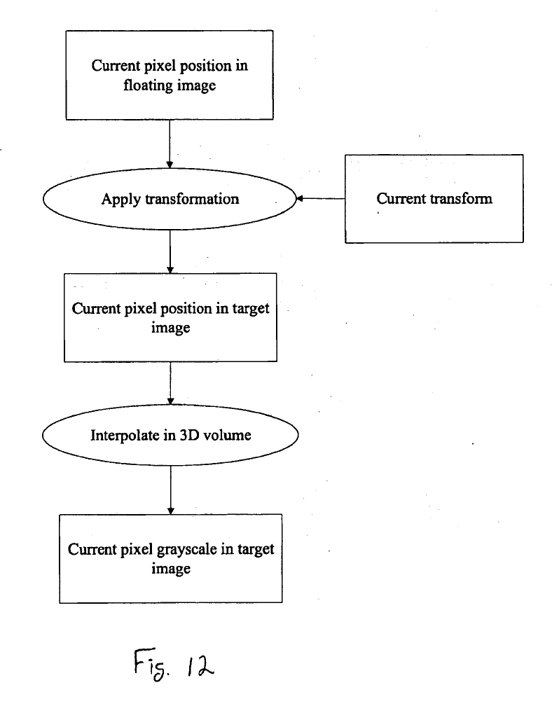

In each iteration of the optimization, parallelism is abundant in 1) transformation of the pixel location of the target image in 3D, 2) acquisition of the target image pixel grayscale value, and 3) computing the final cost by summarizing all pixel values between the floating image and the target image. FIG. 12 shows an object process diagram of the acquisition of target image. This acquisition is described in FIG. 8. This diagram describes the processes involved for each pixel for target image acquisition. On the GPU, all pixels undergo the same processes shown in the diagram in parallel.

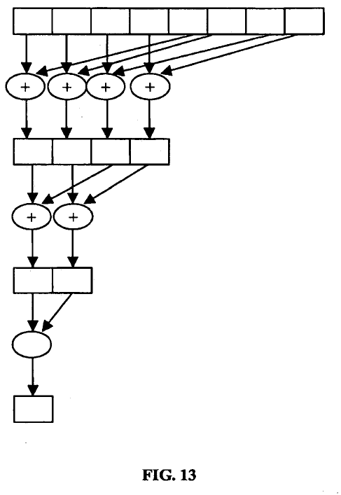

FIG. 13 shows the parallel reduction summation after all pixels are completed in FIG. 12. After all pixel grayscale values are obtained such as the output of the OPD in FIG. 12, the sums of the pixel grayscale values or other processes required by the cost definition are carried out in parallel in the GPU.

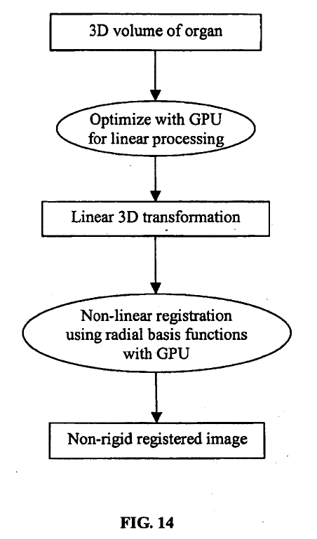

After rigid registration is accomplished, non-rigid registration is carried out between the currently updated 2D live image which includes the current target, and the found 2D target image. FIG. 14 shows the non-rigid registration processes after rigid transformation is completed in FIGS. 11-13. An example of non-rigid registration method is warping using radial basis functions. The function f transforms any point from x to the new position f(x). The two parts of the function are represented by:

$$f ( x ) = {\sum }_{i = 1}^{M} {α}_{i} {φ}_{i} ( x ) + {\sum }_{j = 1}^{N} {β}_{j} R ( ‖ x - {p}_{i} ‖ ) . \qquad ( 1 )$$

The first term is the linear term, in this case the rigid part of registration. The second term is the non-linear term, in this case the radial basis function R(r)=R(∥r∥), where ∥.∥ represents vector norm, and pᵢ is a control point. The two processes in FIG. 14 represent the two terms in Eq. 1 and are carried out on the GPU.

The set of flow diagrams shown in FIGS. 9-13 is explained above. With the updates via optimization of cost (registration) happening in a loop, the prostate animation along with the needle animation will be rendered on the computer screen in real-time to recreate in silico the actions taking place throughout the duration of the entire procedure. With this invention, we have a process of constant refocusing of the needle on a moving target being sought.

1. A method of real-time re-focusing targets, for full-time operation during the entirety of the procedure, when the region containing then undergoes rigid or non-rigid motion. The method is comprised of:
sampling of the floating image and importing to GPU memory in real-time;
gathering the search volume and importing to GPU memory in real-time;
obtaining the target image by interpolating among the voxels of the search volume in parallel from the GPU memory;
evaluating the cost function by operating using GPU operations;
correcting non-rigid motion by means of warping calculations using GPU operations.

2. A method of real-time re-focusing targets, for full-time operation during the entirety of the procedure, when the region containing then undergoes rigid or non-rigid motion. The method is comprised of:
sampling of the floating image and importing to GPU memory in real-time;
gathering the search volume and importing to GPU memory in real-time;
obtaining the target image by interpolating among the voxels of the search volume in parallel from the GPU memory;
evaluating the cost function by operating using GPU operations;
correcting non-rigid motion by means of warping calculations using GPU operations.
where the 2D in 3D search is extended to 3D in 3D search by parallel processing of multiple floating images;

3. A method of real-time re-focusing targets, for full-time operation during the entirety of the procedure, when the region containing then undergoes rigid or non-rigid motion. The method is comprised of:
sampling of the floating image and importing to GPU memory in real-time;
gathering the search volume and importing to GPU memory in real-time;
obtaining the target image by interpolating among the voxels of the search volume in parallel from the GPU memory;
evaluating the cost function by operating using GPU operations;
correcting non-rigid motion by means of warping calculations using GPU operations.
where the 2D in 3D search is extended to 3D in 3D search by parallel processing of multiple floating images;
where the 2D in 3D search is extended to 3D in 3D search incrementally by increasing the available floating image as the probe is moved about over time.

4.-8. (canceled)
